(19) United States
(12) Patent Application Publication
(10) Pub. No.: US 2002/0109996 A1
(43) Pub. Date: Aug. 15, 2002

(54) Decorative light connector

(76) Inventor: Tsui-Tuan Fan Wong, Hsitzu City (TW)

Correspondence Address: Alan Kamrath, RIDER BENNETT EGAN & ARUNDEL, LLP, Suite 2000, 333 South Seventh Street, Minneapolis, MN, 55402, US

(21) Appl. No.: 09/784,778

(22) Filed: Feb. 15, 2001

(51) Int. Cl. H01R 4/24

(52) U.S. Cl. 362/427

(57) ABSTRACT

A decorative light has a first adapter integrally formed with the decorative light and a second adapter integrally formed with the decorative light and opposed to the first adapter. The first adapter has a collar slidably mounted on the decorative light and has inner thread formed to correspond to the outer thread on the second adapter. Therefore, the total length of the decorative light is able to extend by screwing the collar of one decorative light to the second adapter of another decorative light. Furthermore, a plug is able to detachably connect to the first adapter to protect the first adapter from damage.

### BACKGROUND OF THE INVENTION

1. Field of the Invention

The present invention relates to a decorative light connector, and more particularly to a decorative light connector with a connector integrally formed with the light and a plug detachably engaged with the connector. With such an arrangement, the decorative light is able to extend easily and has good water resistance.

2. Description of Related Art

A kind of light is made by numerous small light sources connected in series and coated with flexible and transparent plastic material so that the light can radiate soft light and be decorative. Since the light sources are connected in series, a secure connection between adjacent lights is important. A conventional connector generally has a structure as shown in FIG. 5, which comprises a connection (80) and two tapered sleeves (81). The connection (80) has a plate (801) formed in a middle position of the connection (80) and multiple pins (802) extending through the plate (801). Two male threaded ends of the connection (80) are provided to respectively receive the opposed ends of two adjacent lights (90). Several longitudinal slits (803) are defined in each end of the connection (80). During assembly, two lights (90) are respectively inserted into the respective sleeve (81) and engage with the plate (801) when each of the pins (802) extends into a corresponding one of a set of pin holes (91) in the light (90). Then the tapered sleeves (81) are respectively screwed onto opposite ends of the connection (80) to force the walls with the slits (803) in the ends to clamp the opposed ends of the bulbs (90). This kind of connector device has the disadvantage that difficult operation and a defective contact may occur, since the pins (802) in the connection (80) must precisely align with the pin holes (91) in the bulbs (90).

With reference to FIG. 6, the connection of a light (90) and a power cord (73) is achieved by a connector device similar to the device in FIG. 5. The connector device in FIG. 6 also has a connection (70) and two tapered sleeves (71). A plate (701) is formed in a middle position of the connection (70), and multiple pins (702) extend through the plate (701). Two male threaded ends of the connection (70) are provided to respectively receive the opposed ends of the light (90) and a plug (730) on the power cord (73). Several longitudinal slits (703) are defined in each of the ends of the connection (70). During assembly, the light (90) and the plug (730) are respectively inserted into the respective sleeve (71) and engage with the plate (701) via each of the pins 702 extending into a corresponding one of the multiple pin holes (91) in the bulb (90) and the plug (730). The tapered sleeves (71) are respectively screwed onto the corresponding ends of the connection (70) so as to force the walls with the slits (703) on the ends to clamp the opposed ends of the lamp (90) and the plug (730). From the foregoing description, it is to be understood that the connector device for connecting the light (90) and the power cord (73) also has a disadvantage of difficult operation.

To overcome the shortcomings, the present invention tends to provide an improved decorative light to mitigate and obviate the aforementioned problems.

### SUMMARY OF THE INVENTION

The primary objective of the invention is to provide an improved decorative light with a connector integrally formed with the light and a plug detachably engaged with the connector, such that not only is the connection of the decorative light with another decorative light easy, but also the decorative light has greater water resistance.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the decorative light connector in accordance with the present invention;

FIG. 2 is a partial exploded perspective view of the first adapter of the decorative light connector in FIG. 1;

FIG. 3 is a partial exploded perspective view of the second adapter of the decorative light connector in FIG. 1;

FIG. 4 is a perspective view of a preferred embodiment of a plug in accordance with the present invention;

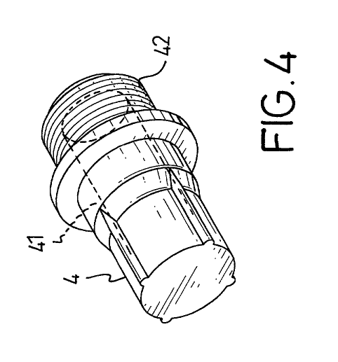

FIG. 5 is an exploded perspective view of a first conventional connector in accordance with the prior art; and

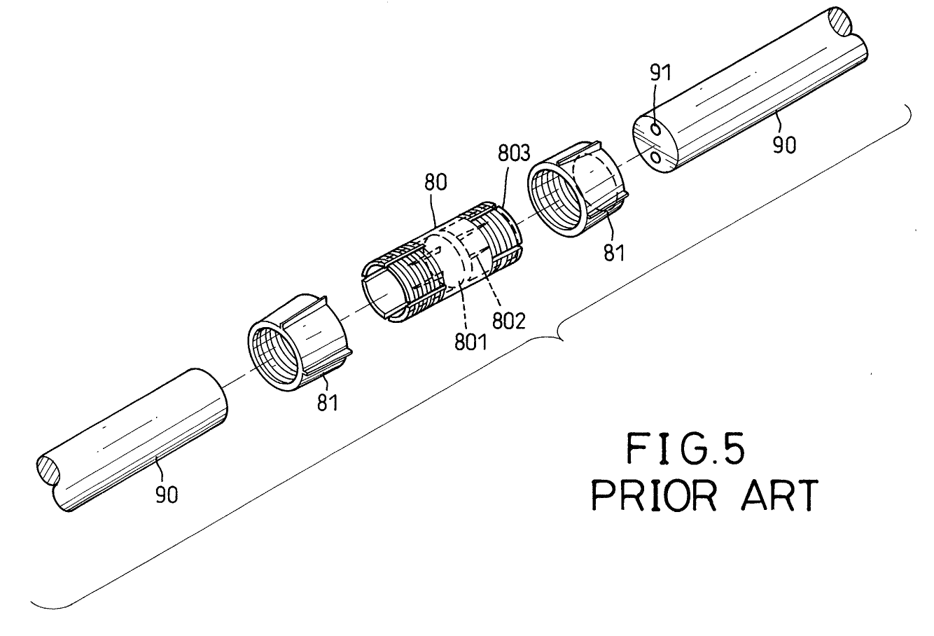

FIG. 6 is an exploded perspective view of a second conventional connector in accordance with the prior art.

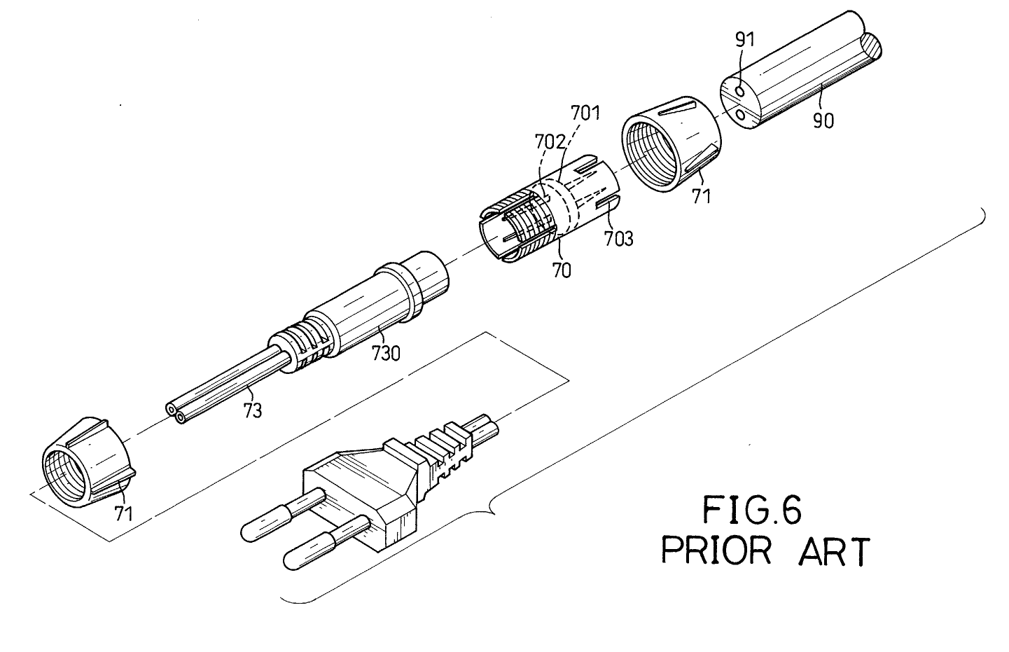

### DETAILED DESCRIPTION OF PREFERRED EMBODIMENT

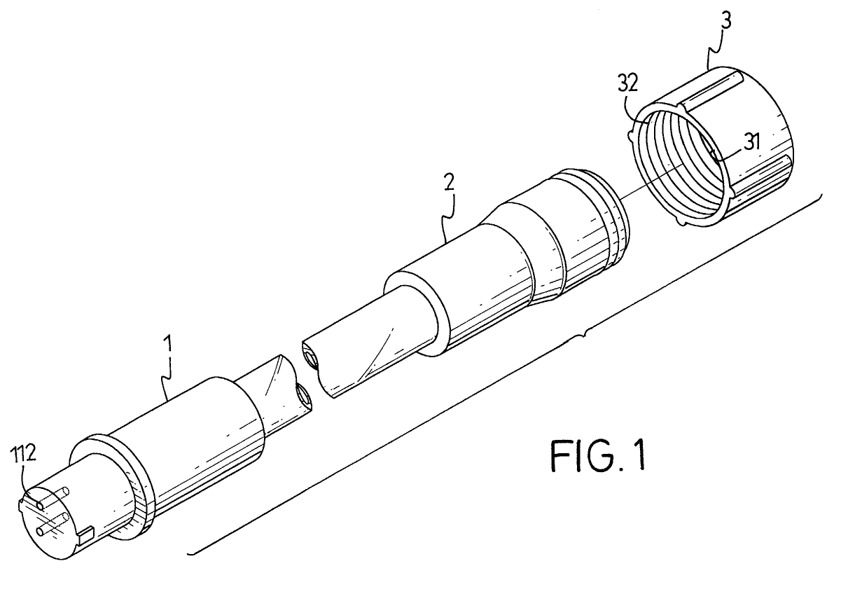

With reference to FIG. 1, the decorative light connector has a first adapter (1), a second adapter (2) and a collar (3).

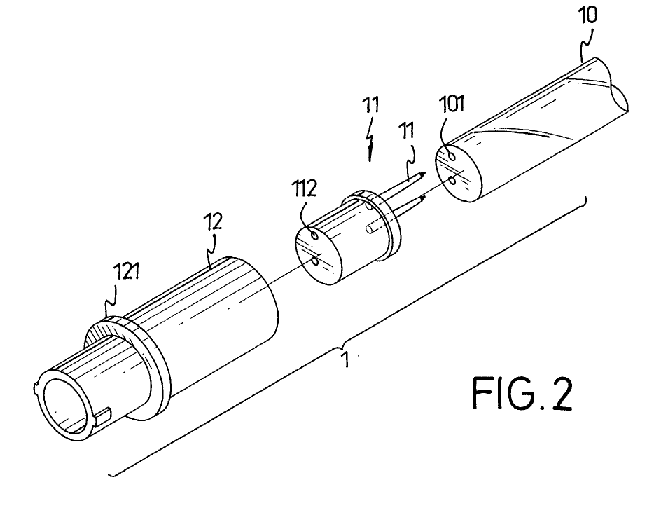

With reference to FIG. 2, the first adapter (1) is securely mounted on one end of the decorative light having multiple light sources (100) connected in series and encased in a resilient and transparent enclosure (10) with two first plated holes (101) defined in the end and connected to the light sources (100). The first adapter (1) has a combination male-female connector (11) with two first pins (111) from one end corresponding to the two first plated holes (101) in the enclosure (10) and two plated second holes (112) in the other end and a resilient cover (12). The resilient cover (12) is formed outside the joint between the combination male-female connector (11) and the enclosure (10) with the two first pins (111) inserted into the corresponding first plated holes (101). In a preferred embodiment of the invention, the resilient cover (12) is formed outside the joint of the combination male-female connector (11) and the enclosure (10) by injection molding, such that the connection between the combination male-female connector (11) and the enclosure (10) has greater water resistance.

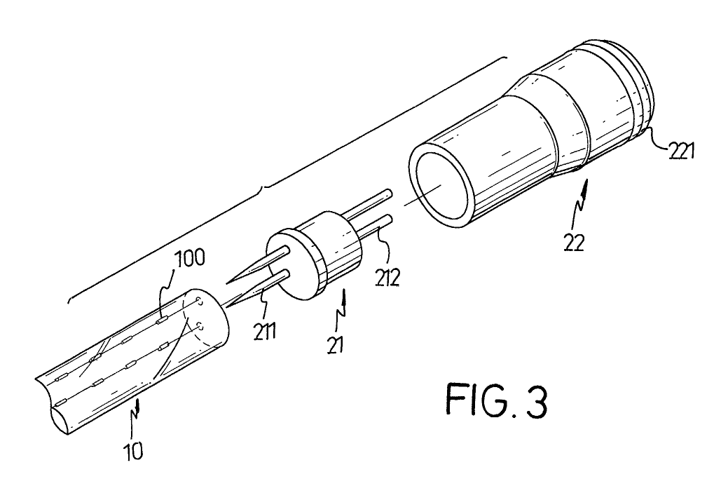

With reference to FIG. 3, the second adapter (2) has a male connector (21) provided with two second pins (211) electrically connected with the light sources (100) inside the enclosure (10), two extended prongs (212) electrically connected with the two second pins (211) and a second cover (22) integrally formed on the joint between the male connector (21) and the enclosure (10) by injection molding after the male connector (21) connects the enclosure (10). The second cover (22) has a thread (221) formed on an outer periphery of the second cover (22).

With reference to FIG. 1, the collar (3) has a through hole (31) defined to allow the extension of the second cover (22) and has an inner thread (32) formed to correspond to the thread (221) on the second cover (22) of another decorative light, such that the collar (3) is able to screw onto the second cover (22) of another decorative light. It is noted that the axial depth of the thread (221) on the second cover (22) is only half of the axial depth of the inner threading (32) of the collar (3) and the collar is slidably movable on the decorative light. To prevent the collar from detachment from the decorative light, the first adapter (1) has a flange (121), as shown in FIGS. 1 and 2, formed on an outer periphery of the first cover (12). The inner diameter of the collar (3) is larger than that of the first cover (12), such that a gap (not numbered) is defined between the first cover (12) and the collar (3). Therefore, when the user wants to extend the total length of the decorative light, the user may use the first adapter (1) of one decorative light to connect to the second cover adapter (2) of another decorative light. After the extended sockets (212) of the male connector (21) are inserted into the corresponding second plated hole (112) of the first adapter (1), the collar (3) is able to screw onto the outer thread (221) of another decorative light so that the total length of the decorative light is lengthened.

It is noted from FIG. 1 that when the decorative is not in use, the two second plated holes (112) are exposed to the air and are easily damaged by environmental changes. To prevent the first adapter (1) from being damaged by the environmental change, a plug (4) having a blind hole (41) defined to allow the extension of the first adapter (1) and a thread (42) formed to correspond to the inner thread (32) of the collar (3) is provided. Thus, when the decorative light of the invention is not in use, the plug (4) is able to threadingly connect with the first adapter (1) to protect the first adapter from damage.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A connector for a decorative light having multiple light sources connected in series and encased in a resilient and transparent enclosure, the connector comprising:
a first adapter adapted to be engaged with the enclosure and having a combination male-female connector provided with two first pins adapted to be electrically connected with the multiple light sources inside the enclosure and two plated holes and a resilient first cover formed outside a joint between the combination male-female connector and the enclosure;
a second adapter adapted to be engaged with the enclosure and having a male connector provided with two second pins adapted to be electrically connected with the light sources inside the enclosure, two extended prongs electrically connected with the two second pins and a second cover integrally formed on a joint between the male connector and the enclosure; and
a collar slidably mounted around the first adapter and having a through hole defined to allow the extension of the second cover and an inner thread formed to correspond to an outer thread on the second cover.

2. The connector as claimed in claim 1, wherein an axial depth of the outer thread on the second cover is a half of an axial depth of the inner thread of the collar, and the collar is slidably movable on the first adapter, such that the collar is able to screw onto the second cover.

3. The connector as claimed in claim 1, wherein the first adapter further has a flange formed on an outer periphery of the first cover to prevent detachment of the collar from the first adapter.

4. The connector as claimed in claim 2, wherein the first adapter further has a flange formed on an outer periphery of the first cover to prevent detachment of the collar from the first adapter.

5. The connector as claimed in claim 1 further comprising a plug detachably connected to the first adapter.

6. The connector as claimed in claim 5, wherein the plug has a blind hole defined to allow the extension of the first adapter and an outer thread formed to correspond to the inner thread of the collar.

7. The connector as claimed in claim 2 further comprising a plug detachably connected to the first adapter.

8. The connector as claimed in claim 7, the plug has a blind hole defined to allow the extension of the first adapter and an outer thread formed to correspond to the inner thread of the collar.

9. The connector as claimed in claim 3 further comprising a plug detachably connected to the first adapter.

10. The connector as claimed in claim 9, wherein the plug has a blind hole defined to allow the extension of the first adapter and an outer thread formed to correspond to the inner thread of the collar.

11. The connector as claimed in claim 4 further comprising a plug detachably connected to the first adapter.

12. The connector as claimed in claim 11, wherein the plug has a blind hole defined to allow the extension of the first adapter and an outer thread formed to correspond to the inner thread of the collar.
